(19) United States
(12) Patent Application Publication
(10) Pub. No.: US 2020/0346701 A1
(43) Pub. Date: Nov. 5, 2020

(54) BULK MATERIAL SHIPPING CONTAINER TRAILER

(71) Applicant: SANDBOX LOGISTICS, LLC, HOUSTON, TX (US)

(72) Inventors: C. John Allegretti, Barrington Hills, IL (US); Kevin S. Corrigan, Forest Park, IL (US)

(21) Appl. No.: 16/402,689

(22) Filed: May 3, 2019

(51) Int. Cl. B62D 63/08; B65D 90/12; B60P 3/00

(52) U.S. Cl. CPC B62D 63/08; B62D 63/068; B60P 3/00; B65D 90/12

(57) ABSTRACT

A bulk material shipping container trailer includes a base structure, a first container support assembly configured to support a full bulk material shipping container, and a second container support assembly configured to break if a full bulk material shipping container is positioned onto the second container support assembly.

### BACKGROUND

Various bulk material shipping containers are known. Such known material bulk shipping containers, sometimes referred to herein for brevity as known containers or as known bulk containers, are used to transport a wide range of products, parts, components, items, and materials such as, but not limited to, seeds, shavings, fasteners, and granular materials (such as sand). These are sometimes called loose materials or materials. New and improved bulk material shipping containers are continuously being developed. For example, U.S. Published Patent Application No. 2018/0002066, which is owned by the assignee of the present application and incorporated herein by reference, discloses relatively new bulk material shipping containers.

As these new bulk material shipping containers are developed, there is a continuing need to develop unloading devices that can be used for unloading loose materials from these new bulk material shipping containers. In various uses, certain of these new bulk material shipping containers need to be supported substantially above the ground to be unloaded. New and improved bulk material shipping container unloader apparatus are continuously being developed. For example, U.S. Published Patent Application No. 2018/002120, which is owned by the assignee of the present application and incorporated herein by reference, discloses relatively new bulk material shipping container unloader apparatus.

As these new bulk material shipping containers are developed, there is a continuing need to develop transporting devices that can be used for transporting these new bulk material shipping containers.

### SUMMARY

Various embodiments of the present disclosure provide bulk material shipping container trailer that meets the above need. Various embodiments of the present disclosure include a base structure, a first container support assembly, and a second container support assembly. The first container support assembly is configured to carry a full bulk material shipping container. The second container support assembly is configured to carry a non-full bulk material shipping container (e.g., empty container), and configured to break in one or more places if a full bulk material shipping container is loaded onto the assembly. In various such embodiments, the second container support assembly does not one or more supports that enables the second container support assembly to hold a full bulk material shipping container. This prevents the trailer from supporting and transporting two full bulk material shipping containers, ensuring that road and other weight restrictions are met.

Additional features and advantages of the present invention are described in, and will be apparent from, the following Detailed Description of Exemplary Embodiments and the figures.

### DESCRIPTION OF THE DRAWINGS

FIG. 1 is a top view of the bulk material shipping container trailer of one example of the present disclosure.

FIG. 2 is a side view of the bulk material shipping container trailer of FIG. 1.

### DETAILED DESCRIPTION OF EXEMPLARY EMBODIMENTS

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connection of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, etc., are not intended to be limited to direct mounting methods, but should be interpreted broadly to include indirect and operably coupled, mounted, connected, and like mounting methods. This specification is intended to be taken as a whole and interpreted in accordance with the principles of the present disclosure and as understood by one of ordinary skill in the art.

Bulk material shipping containers are often used to transport a wide range of products, parts, components, items, and materials such as, but not limited to, seeds, shavings, fasteners, and granular materials (such as sand). These are sometimes called loose materials or simply materials. To make use of and/or store these materials appropriately, the bulk material shipping containers must be transported from one location to another. In some cases, this transport can be done via train. However, in other cases such as for the “last mile” of transport, bulk material shipping containers may instead be transported over land via a trailer attached to a transport vehicle. Due to weight restrictions of the roads, trailers, and/or transport vehicles themselves, for various such bulk material shipping containers, only one full container may be transported by a given vehicle and trailer at a time. However, it may be desirable to transport one or more empty containers from one location to another, at the same time a full container is being transported. This added efficiency of transport can reduce costs, reduce the number of needed trailers and transport vehicles, and provide various other benefits. Enabling a trailer to transport two or more containers simultaneously, however, introduces the potential for a single trailer to transport two full containers, going against the weight restrictions of the road, trailer, and/or transport vehicle.

With this issue in mind, various embodiments of the present disclosure provides a trailer having two container support assemblies, configured to carry two containers on a single trailer. A first container support assembly is configured to carry a full container. The second container support assembly is configured to carry a non-full container (e.g., empty container), and is configured to break if a full container is loaded onto that second container support assembly. In this manner, the example trailer prevents two full containers from be transported, ensuring that any weight restrictions are met.

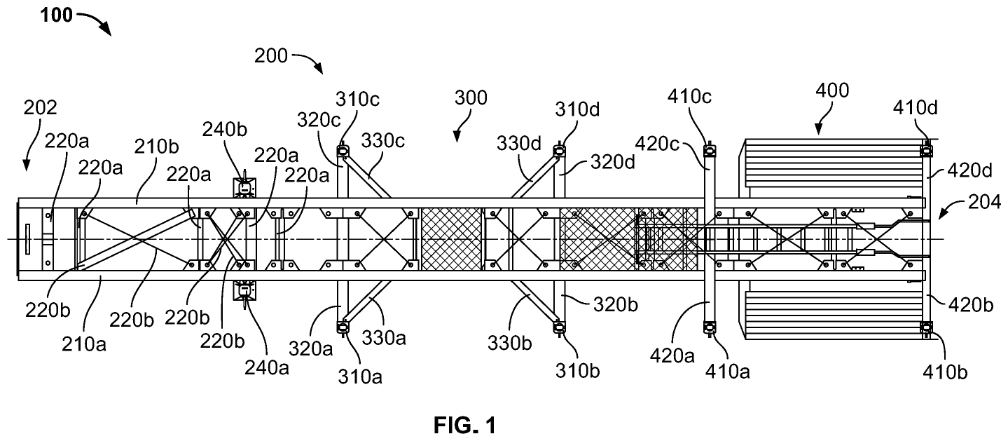

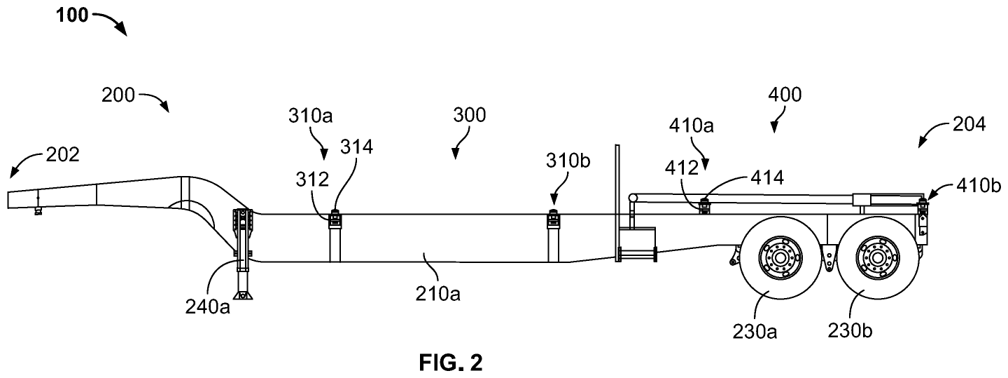

Referring now to FIGS. 1 and 2, an example embodiment of the present disclosure illustrated wherein the bulk material shipping container trailer is indicated by numeral 100.

The bulk material shipping container trailer 100 (referred to herein simply as the “trailer” for brevity) is configured to accommodate two bulk material shipping containers (not shown) such as the bulk material shipping container shown in U.S. Published Patent Application No. 2018/0002066. The trailer 100 includes container support assemblies for the two bulk material shipping containers, spaced apart such that a first bulk material shipping container is positioned in a center of the trailer 100, and a second bulk material shipping container is positioned at a rear of the trailer.

The trailer 100 includes a base structure 200, a first container support assembly 300, and a second container support assembly 400.

The base structure 200 includes a front end 202, a rear end 204, longitudinal members 210a and 210b, a plurality of lateral connection members 220a and 220b, wheelsets 230a and 230b, and front ground support members 240a and 240b.

The base structure 200 of the trailer 100 is configured to be removably attached to a transport vehicle (not shown) proximate the front end 202.

The longitudinal members 210a and 210b of the base structure 200 extend along a length of the trailer 100 from the front end 202 to the rear end 204. The longitudinal members 210a and 210b are generally parallel to each other when viewed from above, as shown in FIG. 1. The longitudinal members 210a and 210b are generally identical to each other, but with a reversed or mirrored orientation. The longitudinal members 210a and 210b includes two substantially horizontal portions, which enable the container support assemblies 300 and 400 respectively to support bulk material shipping containers with substantially level surfaces. A first substantially horizontal portion is positioned in a middle of the longitudinal members 210a and 210b between the front end 202 and the rear end 204, and is connected to the first container support assembly 300. A second substantially horizontal portion is positioned proximate the rear end 204, and is connected to the second container support assembly 400. The longitudinal members 210a and 210b include an upright curvature (i.e., the curvature occurs in a vertical or substantially vertical plane) proximate the front end 202. The curvature enables the connection to the transport vehicle to be higher than the container support assemblies, such that the bulk material shipping containers can be transported lower to the ground, thereby providing additional stability to the trailer 100. The longitudinal members 210a and 210b may be made from steel or any other suitably strong material or combination of materials, and may include portions that have an I-beam design, or any other appropriate configuration.

The plurality of lateral connection members 220a and 220b include members that extend between and are connected to both longitudinal members 210a and 210b. The lateral connection members 220a extend transversely or perpendicularly to a longitudinal axis of the longitudinal members 210a and 210b. The lateral connection members 220b extend at a non-perpendicular angle with respect to the longitudinal axis of the longitudinal members 210a and 210b.

The wheelsets 230a and 230b include corresponding axles, bearings, wheels, and other appropriate wheelset components (not shown or individually labeled).

The front ground support members 240a and 240b are each configured to transition from a stowed position to a ground engaging position. Each front ground support member 240a and 240b is extendable toward the ground, so as to enable the trailer 100 (and/or portions of the trailer 100) to be level with respect to the ground, particularly when the trailer 100 is not attached to the transport vehicle. The front ground support members 240a and 240b also assist in transitioning the trailer from being attached to the transport vehicle to being unattached, and vice versa.

The first container support assembly 300 is positioned in a middle of the trailer 100, between the front end 202 and the rear end 204 of the base structure 200. The first container support assembly 300 is connected to the base structure 200 at the first substantially horizontal portion in the middle of the trailer 100. The first container support assembly 300 is configured to support a full bulk material shipping container. In some cases, the full bulk material shipping container weighs approximately 50,000 lbs. It should be appreciated that different shipping containers may be used. One example shipping container may be rated for up to 55,000 lbs. This container itself may weigh about 4200 lbs., and a typical payload may weigh about 46,500 lbs. Another example shipping container may be rated for up to 50,000 lbs. This container itself may weigh about 3800 lbs., and a typical payload may weigh about 41,000 lbs.

The first container support assembly 300 includes first, second, third, and fourth corner nesting supports 310a, 310b, 310c, and 310d; first, second, third, and fourth lateral support arms 320a, 320b, 320c, and 320d; and first, second, third, and fourth angled support arms 330a, 330b, 330c, and 330d.

The first, second, third, and fourth corner nesting supports 310a-d are each configured to engage and assist in correctly aligning the first bulk material shipping container on the trailer 100. The corner nesting supports 310a-d are spaced apart from each other (via connections to the lateral support arms 320a-d and angled support arms 330a-d) such that they are configured to engage the bottom corners of a standard sized bulk material shipping container such as the bulk material shipping container shown in U.S. Published Patent Application No. 2018/0002066. It should be appreciated that the corner nesting supports 310a-d are substantially similar in the illustrated example embodiment. Thus, for brevity, only the corner nesting support 310a is further described in detail.

Specifically, as shown in FIGS. 1-2, the corner nesting support 310a includes a base 312 and a container engagement member 314. The base 312 is connected on a bottom end to the lateral support arm 320a and/or the angled support arm 330a. The container engagement member 314 is connected to a top of the base 312, and is configured to engage a bottom corner of a bulk material shipping container (not shown). The container engagement member 314 has a tubular shape, and extends upwardly from the base 312. The base 312 and/or container engagement member 314 may be made from steel or any other suitably strong material.

The first, second, third, and fourth lateral support arms 320a-d are each configured to provide lateral and vertical support to the corner nesting supports 310a-d, and thus to support a bulk material shipping container positioned on the corner nesting supports 310a-d. It should be appreciated that the lateral support arms 320a-d are substantially similar to each other in the illustrated example embodiment. Thus, for brevity, only the lateral support arm 320a is further described in detail.

The lateral support arm 320a extends laterally with respect to the longitudinal axis of the longitudinal members 210a and 210b. On a first end, the lateral support arm 320a is connected to the first corner nesting support 310a. On a second end opposite the first end, the lateral support arm is connected to the first longitudinal member 210a. Alternatively, lateral support arms 320a and 320c may be integrally formed with each other (e.g., a single arm), such that the combined lateral arm is connect to the first corner nesting support 310a at a first end, and to the third corner nesting support 310c at a second end. The combined lateral arm is then connected to the first and second longitudinal members 210a and 210b near the middle of the combined arm as shown in FIG. 1. The lateral support arm 320a may be connected to the longitudinal member 210a by welding, one or more fasteners, or any other suitable connection mechanism.

The lateral support arm 320a is substantially horizontal as shown in the embodiment of FIGS. 1 and 2, such that a top of the lateral support arm 320a is flush with a top of the longitudinal member 210a. It should be appreciated that alternative embodiments may include the lateral support arm 320a being connected at an angle with respect to the longitudinal member 210a, such that a connection to the longitudinal member 210a is lower than a connection to the first corner nesting support 310a. The lateral support arm 320a is configured to support the weight of a full bulk material shipping container (e.g., such as up to 50,000 lbs. or more) without breaking.

The first, second, third, and fourth angled support arms 330a-d are each configured to provide primarily lateral support to the lateral support arms 320a-d and corner nesting supports 310a-d. The angled support arms are configured to prevent forward and backward movement of the bulk material shipping container when positioned on the first container support assembly 300. It should be appreciated that the angled support arms 330a-d are substantially similar in the illustrated example embodiment. Thus, for brevity, only the angled support arm 330a is further described in detail.

The angled support arm 330a extends from the first longitudinal member 210a at an angle with respect to the longitudinal axis of the longitudinal members 210a and 210b. On a first end, the angled support arm 330a is connected to the first corner nesting support 310a and/or the first lateral support arm 320a. On a second end opposite the first end, the angled support arm is connected to the first longitudinal member 210a. The angled support arm 330a may be connected to the longitudinal member 210a, the lateral support arm 320a, and/or the first corner nesting support 310a by welding, one or more fasteners, or any other suitable connection mechanism.

The angled support arm 330a extends from the first longitudinal member 210a at a position near or proximate the center of the first container support assembly 300. As shown in FIG. 1, the first angled support arm 330a is a front support arm (as opposed to angled support arm 330b, which is a rear support arm). As such, the first angled support arm 330a connects to the first longitudinal member 210a at a position more rearward relative to the connection position for the corresponding lateral support arm 320a. In contrast, the second angled support arm 330b connects to the first longitudinal member 210a at a position more frontward relative to the connection position for the corresponding lateral support arm 320b.

The angled support arm 330a is substantially horizontal as shown in the embodiment of FIGS. 1 and 2, such that a top of the angled support arm 330a is flush with a top of the longitudinal member 210a. It should be appreciated that alternative embodiments may include the angled support arm 330a being connected at an angle with respect to the longitudinal member 210a, such that a connection to the longitudinal member 210a is lower than a connection to the first corner nesting support 310a and/or lateral support arm 320a. The angled support arm 330a is configured to reduce forward and/or backward flexing or movement of the lateral support arm 320a.

The second container support assembly is positioned above the wheelsets 230a and 230b of the base structure 200. The second container support assembly 400 includes first, second, third, and fourth corner nesting supports 410a, 410b, 410c, and 410d, and first, second, third, and fourth lateral support arms 420a, 420b, 420c, and 420d.

The first, second, third, and fourth corner nesting supports 410a-d are each configured to engage and assist in correctly aligning the second bulk material shipping container on the trailer 100. The corner nesting supports 410a-d are spaced apart from each other (via connections to the lateral support arms 420a-d) such that they are configured to engage the bottom corners of a standard sized bulk material shipping container such as the bulk material shipping container shown in U.S. Published Patent Application No. 2018/0002066. It should be appreciated that the corner nesting supports 410a-d are substantially similar in the illustrated example embodiment. Thus, for brevity, only the corner nesting support 410a is further described in detail.

Specifically, as shown in FIGS. 1 and 2, the corner nesting support 410a includes a base 412 and a container engagement member 414. The base 412 is connected on a bottom end to the lateral support arm 420a. The container engagement member 414 is connected to a top of the base 412, and is configured to engage a bottom corner of a bulk material shipping container (not shown). The container engagement member 414 has a tubular shape, and extends upwardly from the base 412. The base 412 and/or container engagement member 414 may be made from steel or any other suitably strong material.

The first, second, third, and fourth lateral support arms 420a-d are each configured to provide lateral and vertical support to the corner nesting supports 410a-d, and thus to support an empty bulk material shipping container positioned on the corner nesting supports 410a-d. It should be appreciated that the lateral support arms 420a-d are substantially similar to each other in the illustrated example embodiment. Thus, for brevity, only the lateral support arm 420a is further described in detail.

The lateral support arm 420a extends laterally with respect to the longitudinal axis of the longitudinal members 210a and 210b. On a first end, the lateral support arm 320a is connected to the first corner nesting support 410a. On a second end opposite the first end, the lateral support arm is connected to the first longitudinal member 210a. Alternatively, lateral support arms 420a and 420c may be integrally formed with each other (e.g., a single arm), such that the combined lateral arm is connect to the first corner nesting support 410a at a first end, and to the third corner nesting support 410c at a second end. The combined lateral arm is then connected to the first and second longitudinal members 210a and 210b near the middle of the combined arm as shown in FIG. 1. The lateral support arm 420a may be connected to the longitudinal member 210a by welding, one or more fasteners, or any other suitable connection mechanism.

The lateral support arm 420a is substantially horizontal as shown in the embodiment of FIGS. 1 and 2, such that a top of the lateral support arm 420a is flush with a top of the longitudinal member 210a. It should be appreciated that alternative embodiments may include the lateral support arm 420a being connected at an angle with respect to the longitudinal member 210a, such that a connection to the longitudinal member 210a is lower than a connection to the first corner nesting support 410a. The lateral support arm 420a is configured to support the weight of an empty bulk material shipping container in connection with the other three lateral support arms 420b-d (e.g., up to 5,000 lbs. or more), but is configured to break if a full container is loaded onto the second container support assembly 400. It should be appreciated that different thresholds and breaking points may be used. In one example, the threshold may be approximately 20,000 lbs. If a container weighing more than 20,000 lbs. is loaded onto the corner nesting supports 410a-d, one or more of the lateral support arms 420a-d may break. The breaking point may be at a connection to the corresponding corner nesting support, at a connection point between the lateral support arm and the longitudinal members of the trailer (e.g., at the “bolster” connection to the trailer), or at another point of the lateral connection arm.

In this illustrated example embodiment, the second container support assembly 400 does not include the angled support arms as generally shown in FIGS. 1 and 2. There are no angled support arms for this second container support assembly to reduce the overall weight and complexity of the trailer 100. In addition, the lateral strength of the lateral support arms 410a-d is sufficient to prevent lateral movement of the non-full or empty container without the need for additional lateral stability members.

It should be appreciated that the present disclosure contemplates that the second container support assembly can be otherwise suitably configured to break in one or more places if a full bulk material shipping container is placed on such support assembly. For example, in certain such embodiments, the support assembly can include one or more weakened areas or one or more areas specifically configured to break if too much weight is placed on the support assembly.

It should be understood that modifications and variations may be effected without departing from the scope of the novel concepts of the present disclosure, and it should be understood that this application is to be limited only by the scope of the appended claims.

The invention is claimed as follows:

1. A bulk material shipping container trailer comprising:
a base structure;
a first container support assembly including:
one or more first corner nesting supports; and
one or more first lateral support arms,
wherein the one or more first lateral support arms are configured to support a full bulk material shipping container; and
a second container support assembly including:
one or more second corner nesting supports; and
one or more second lateral support arms,
wherein the one or more second lateral support arms are configured to break when a full bulk material shipping container is positioned on the second container support assembly.

2. The bulk material shipping container trailer of claim 1, wherein the first container support assembly is positioned at a center of the base structure along a longitudinal axis of the base structure.

3. The bulk material shipping container trailer of claim 1, wherein the second container support assembly is positioned at a rear of the base structure along a longitudinal axis of the base structure.

4. The bulk material shipping container trailer of claim 3, wherein the second container support assembly is positioned above a wheelset of the base structure.

5. The bulk material shipping container trailer of claim 1, wherein the one or more first lateral support arms are each connected to the base structure and to one of the one or more first corner nesting supports.

6. The bulk material shipping container trailer of claim 1, wherein the first container support assembly further includes one or more angled support arms, wherein each angled support arm is connected to the base structure and to one of the one or more first lateral support arms.

7. The bulk material shipping container trailer of claim 6, wherein the second container support assembly does not include any angled support arms.

8. The bulk material shipping container trailer of claim 1, wherein the one or more second lateral support arms are each connected to the base structure and to one of the one or more second corner nesting supports.

9. The bulk material shipping container trailer of claim 1, wherein the one or more second lateral support arms are configured to break at respective connection points to the base structure when a bulk material shipping container having a weight greater than a threshold weight is positioned on the second container support assembly.

10. The bulk material shipping container trailer of claim 9, wherein the threshold weight is 20,000 lbs.

11. A bulk material shipping container trailer comprising:
a base structure;
a first container support assembly including:
four first lateral support arms each connected to and each extending outwardly from the base structure, and
four first corner nesting supports respectively connected to connected to the four first lateral support arms, wherein the first lateral support arms are configured to support a full bulk material shipping container; and
a second container support assembly including:
four second lateral support arms each connected to and each extending outwardly from the base structure, and
four second corner nesting supports respectively connected to the four second lateral support arms, wherein one or more of the four second lateral support arms are configured to break when a full bulk material shipping container is positioned on the second container support assembly.

12. The bulk material shipping container trailer of claim 11, wherein the first container support assembly is positioned at a center of the base structure along a longitudinal axis of the base structure.

13. The bulk material shipping container trailer of claim 12, wherein the second container support assembly is positioned at a rear of the base structure along the longitudinal axis of the base structure.

14. The bulk material shipping container trailer of claim 13, wherein the second container support assembly is positioned above a wheelset of the base structure.

15. The bulk material shipping container trailer of claim 11, wherein the first container support assembly further includes four angled support arms, wherein each angled support arm is connected to the base structure and to a respective one of the four first lateral support arms.

16. The bulk material shipping container trailer of claim 15, wherein the second container support assembly does not include any angled support arms.

17. The bulk material shipping container trailer of claim 11, wherein one or more of the four second lateral support arms are configured to break at respective connection points to the base structure when a bulk material shipping container having a weight greater than a threshold weight is positioned on the second container support assembly.

18. The bulk material shipping container trailer of claim 17, wherein the threshold weight is 20,000 lbs.
